(19) United States
(12) Patent Application Publication
(10) Pub. No.: US 2026/0081460 A1
(43) Pub. Date: Mar. 19, 2026

(54) BACKUP POWER SUPPLY SYSTEM AND MOVING VEHICLE

(71) Applicant: Panasonic Intellectual Property Management Co., Ltd., Osaka (JP)

(72) Inventors: Hiroki AKASHI, Osaka (JP); Yuta NAGATOMI, Osaka (JP); Takashi KAWAI, Fukui (JP); Masaki NAKAMURA, Fukui (JP); Yo KUMODA, Osaka (JP)

(73) Assignee: Panasonic Intellectual Property Management Co., Ltd., Osaka (JP)

(21) Appl. No.: 19/106,505

(22) PCT Filed: Aug. 21, 2023
(86) PCT No.: PCT/JP2023/029934

§ 371 Date: Nov. 25, 2025

(30) Foreign Application Priority Data
Aug. 31, 2022 (JP) 2022-138769

(51) Int. Cl. H02J 9/06; H02J 7/00; H02J 7/34

(52) U.S. Cl. CPC H02J 9/068; H02J 7/342; H02J 7/855; H02J 7/865; H02J 7/933; H02J 2105/30

(57) ABSTRACT

The problem to be overcome by the present disclosure is to reduce waste of an electrical storage unit. A backup power supply system (1) includes an electrical storage unit (2) and a control unit (3). The electrical storage unit (2) supplies electric power to a load (4) according to an electrical characteristic of a main power supply (5). The main power supply (5) supplies electric power to the load (4). The control unit (3) controls the supply of the electric power from the main power supply (5) and the electrical storage unit (2) to the load (4). The load (4) includes a first load (41) and a second load (42). When the electrical characteristic of the main power supply (5) is equal to or greater than a first threshold value (Vth1), the control unit (3) performs control to have both the first load (41) and the second load (42) supplied with the electric power from the main power supply (5). When the electrical characteristic of the main power supply (5) is less than the first threshold value (Vth1), the control unit (3) performs control to have the second load (42) supplied with the electric power from the main power supply (5) and have the first load (41) supplied with the electric power from the electrical storage unit (2).

### TECHNICAL FIELD

The present disclosure relates to a backup power supply system for supplying electric power to a load and a moving vehicle.

### BACKGROUND ART

Patent Literature 1 discloses an onboard backup device including: a power supply unit for supplying electric power to a target to be supplied with electric power (hereinafter simply referred to as a “target”); an electrical path serving as a path through which the electric power is supplied from the power supply unit to the target; and an electrical storage unit serving as a power supply source at least when the supply of the electric power from the power supply unit has failed.

An onboard backup device such as the one disclosed in Patent Literature 1 is increasingly required to reduce waste of the electrical storage unit.

### CITATION LIST

### Patent Literature

Patent Literature 1: JP 2018-64407 A

### SUMMARY OF INVENTION

In view of the foregoing background, it is therefore an object of the present disclosure to provide a backup power supply system having the ability to reduce waste of an electrical storage unit and also provide a moving vehicle.

A backup power supply system according to an aspect of the present disclosure includes an electrical storage unit and a control unit. The electrical storage unit supplies electric power to a load according to an electrical characteristic of a main power supply. The main power supply supplies electric power to the load. The control unit controls the supply of the electric power from the main power supply and the electrical storage unit to the load. The load includes a first load and a second load. When the electrical characteristic of the main power supply is equal to or greater than a first threshold value, the control unit performs control to have both the first load and the second load supplied with the electric power from the main power supply. When the electrical characteristic of the main power supply is less than the first threshold value, the control unit performs control to have the second load supplied with the electric power from the main power supply and have the first load supplied with the electric power from the electrical storage unit.

A moving vehicle according to another aspect of the present disclosure includes the backup power supply system described above and a moving vehicle body to be equipped with the backup power supply system, the main power supply, and the load.

### BRIEF DESCRIPTION OF DRAWINGS

FIG. 1 is a schematic circuit diagram of a backup power supply system according to an exemplary embodiment of the present disclosure;

FIG. 2 is a schematic circuit diagram of the backup power supply system;

FIG. 3 is a schematic circuit diagram of the backup power supply system;

FIG. 4 is a schematic circuit diagram of the backup power supply system;

FIG. 5 illustrates how the backup power supply system operates;

FIG. 6 is a partially cutaway side view of a vehicle equipped with the backup power supply system;

FIG. 7 is a schematic circuit diagram of a backup power supply system according to a first variation;

FIG. 8 illustrates how the backup power supply system operates;

FIG. 9 is a schematic circuit diagram of a backup power supply system according to a second variation;

FIG. 10 illustrates how the backup power supply system operates;

FIG. 11 is a schematic circuit diagram of a backup power supply system according to a third variation; and

FIG. 12 illustrates how the backup power supply system operates.

### DESCRIPTION OF EMBODIMENTS

A backup power supply system 1 according to an exemplary embodiment of the present disclosure will now be described in detail with reference to the accompanying drawings. Note that the embodiment and its variations to be described below are only an exemplary one of various embodiments of the present disclosure and its variations and should not be construed as limiting. Rather, the exemplary embodiment and its variations may be readily modified in various manners depending on a design choice or any other factor without departing from a true spirit and scope of the present disclosure.

### (1) Overview

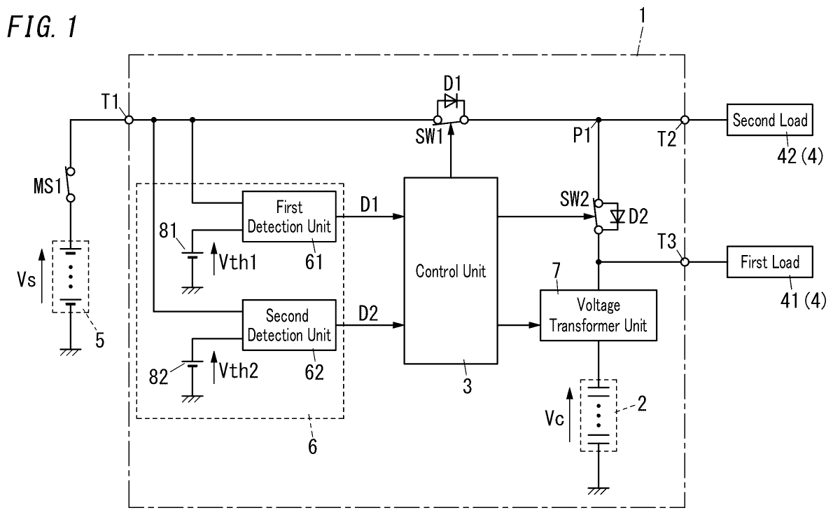

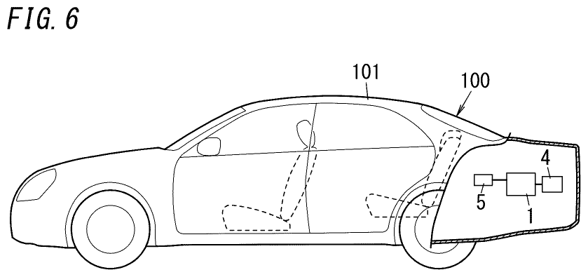

First of all, an overview of a backup power supply system 1 according to an exemplary embodiment will be described with reference to FIGS. 1 and 6.

As shown in FIG. 1, the backup power supply system 1 includes an electrical storage unit 2 and a control unit 3.

The electrical storage unit 2 supplies electric power to a load 4 according to an electrical characteristic of a main power supply 5. The main power supply 5 supplies electric power to the load 4.

The control unit 3 controls the supply of the electric power from the main power supply 5 and the electrical storage unit 2 to the load 4.

The load 4 includes a first load 41 and a second load 42.

When the electrical characteristic of the main power supply 5 is equal to or greater than a first threshold value Vth1, the control unit 3 performs control to have both the first load 41 and the second load 42 supplied with the electric power from the main power supply 5. On the other hand, when the electrical characteristic of the main power supply 5 is less than the first threshold value Vth1, the control unit 3 performs control to have the second load 42 supplied with the electric power from the main power supply 5 and have the first load 41 supplied with the electric power from the electrical storage unit 2. That is to say, if the electrical characteristic of the main power supply 5 is less than the first threshold value Vth1, the control unit 3 determines that the main power supply 5 have caused a failure with respect to the first load 41 and performs control to have the first load 41 supplied with the electric power from the electrical storage unit 2. In addition, even if the electrical characteristic of the main power supply 5 is less than the first threshold value Vth1, the control unit 3 determines that the main power supply 5 have caused no failure with respect to the second load 42 and performs control to have the second load 42 supplied with the electric power from the main power supply 5. As used herein, the expression “the main power supply 5 has caused a failure with respect to the load 4” refers to a state where the electrical characteristic of the main power supply 5 is less than a minimum required value for the load 4 to operate properly.

As can be seen, in a situation where the main power supply 5 has caused a failure with respect to the first load 41 but the electrical characteristic of the main power supply 5 has a sufficient value for the second load 42 to operate properly, the backup power supply system 1 according to this embodiment allows the second load 42 to be supplied with electric power from the main power supply 5. This enables reducing waste of the electrical storage unit 2 compared to a situation where the second load 42 is supplied with electric power from the electrical storage unit 2 even when the electrical characteristic of the main power supply 5 has a sufficient value for the second load 42 to operate properly.

The backup power supply system 1 according to this embodiment is installed in a moving vehicle such as a vehicle 100 (refer to FIG. 6), for example. That is to say, the moving vehicle (vehicle 100) includes the backup power supply system 1 and a moving vehicle body 101 (such as the body of the vehicle 100). The moving vehicle body 101 is equipped with the backup power supply system 1, the main power supply 5, and the load 4 (including the first load 41 and the second load 42). Note that FIG. 6 schematically illustrates a state where the vehicle 100 is equipped with the main power supply 5 and the backup power supply system 1 and should not be construed as limiting the installation locations of the main power supply 5 and the backup power supply system 1. In general, the main power supply 5 and the backup power supply system 1 are installed somewhere between an engine room at the front of the vehicle 100 and a console box. Nevertheless, the installation locations of the main power supply 5 and the backup power supply system 1 may be changed as appropriate.

In this embodiment, the backup power supply system 1 is supposed to be installed in the vehicle 100 as an example. However, the moving vehicle does not have to be the vehicle 100 but may also be an aircraft, a watercraft, or a railway train, for example. Furthermore, the backup power supply system 1 does not have to be installed in a moving vehicle but may also be installed and used in a facility, for example.

### (2) Details

Next, a backup power supply system 1 according to this embodiment will be described in detail with reference to FIGS. 1-6.

### (2.1) Overall Configuration

As shown in FIGS. 1-4, the backup power supply system 1 includes the electrical storage unit 2, a first connection terminal T1, a second connection terminal T2, a third connection terminal T3, a first switch SW1, a second switch SW2, a detection unit 6, the control unit 3, and a voltage transformer unit 7.

A main power supply 5, which may be a battery installed in the vehicle 100, for example, is connected to the first connection terminal T1 via a main switch MS1 provided for the vehicle 100 (refer to FIG. 6). When the main switch MS1 turns ON, a supply voltage Vs is supplied from the main power supply 5 to the first connection terminal T1.

The second load 42 is connected to the second connection terminal T2. The second load 42 may be, for example, an electric power steering system installed in the vehicle 100.

The first load 41 is connected to the third connection terminal T3. The first load 41 is a load having a higher minimum operating voltage than the second load 42. As used herein, the “minimum operating voltage” refers to a minimum voltage value falling within a voltage range where the load operates properly. The first load 41 may be, for example, an electric braking system installed in the vehicle 100.

The electrical storage unit 2 may be, for example, an electrical double layer capacitor (EDLC) which may be charged and discharged rapidly. The electrical storage unit 2 may be made up of two or more electrical storage devices (such as electrical double layer capacitors) which are electrically connected in parallel or in series. Alternatively, the electrical storage unit 2 may also be made up of a plurality of electrical storage devices which are electrically connected in parallel and in series. That is to say, the electrical storage unit 2 may be implemented as a parallel circuit or series circuit of two or more electrical storage devices or a combination thereof.

The electrical storage unit 2 is charged with the supply voltage Vs supplied from the main power supply 5.

The first switch SW1 may be, for example, a p-channel metal-oxide semiconductor field effect transistor (MOSFET). The first switch SW1 is connected between the first connection terminal T1 and the second connection terminal T2. That is to say, the first switch SW1 is connected between the main power supply 5 and the second load 42. A body diode D1 is provided for the first switch SW1. The body diode D1 has an anode connected to the first connection terminal T1 and a cathode connected to the second connection terminal T2. That is to say, the body diode D1 is connected in such a direction as to cause a current to flow from the first connection terminal T1 toward the second connection terminal T2.

The first switch SW1 is turned ON and OFF by the control unit 3.

The second switch SW2 may be, for example, a p-channel MOSFET. The second switch SW2 is connected between a connection node P1 where the first switch SW1 and the second connection terminal T2 are connected to each other and the third connection terminal T3. That is to say, the second switch SW2 is connected between the first switch SW1 and the first load 41. A body diode D2 is provided for the second switch SW2. The body diode D2 has an anode connected to the connection node P1 and a cathode connected to the third connection terminal T3. That is to say, the body diode D2 is connected in such a direction as to cause a current to flow from the connection node Pl toward the third connection terminal T3.

The second switch SW2 is turned ON and OFF by the control unit 3.

The detection unit 6 detects the electrical characteristic of the main power supply 5. In this embodiment, the electrical characteristic of the main power supply 5 to be detected by the detection unit 6 is the supply voltage Vs supplied from the main power supply 5 to the first connection terminal T1.

The detection unit 6 includes a first detection unit 61, a first reference voltage source 81, a second detection unit 62, and a second reference voltage source 82. Each of the first detection unit 61 and the second detection unit 62 may include, for example, a differential amplifier.

The first detection unit 61 detects the value of the supply voltage Vs supplied to the first connection terminal T1 and compares the value of the supply voltage Vs with the value of a first reference voltage (first threshold value) Vth1 supplied from the first reference voltage source 81.

The first threshold value Vth1 may be set at, for example, a value equal to the minimum operating voltage of the first load 41. That is to say, if the value of the supply voltage Vs is less than the first threshold value Vth1, then the first load 41 cannot operate properly, and therefore, the main power supply 5 is determined to have caused a failure with respect to the first load 41.

The first detection unit 61 outputs a detection signal D1, which is a voltage signal representing the result of comparison between the value of the supply voltage Vs and the first threshold value Vth1, to the control unit 3. Specifically, if the value of the supply voltage Vs is equal to or greater than the first threshold value Vth1, the first detection unit 61 outputs a detection signal D1 having a voltage value VLo1 to the control unit 3. On the other hand, if the value of the supply voltage Vs is less than the first threshold value Vth1, the first detection unit 61 outputs a detection signal D1, having a voltage value VHi1 higher than the voltage value VLo1, to the control unit 3. In other words, if the main power supply 5 has caused a failure with respect to the first load 41, the first detection unit 61 outputs the detection signal D1 having the voltage value VHi1 to the control unit 3.

The second detection unit 62 detects the value of the supply voltage Vs supplied to the first connection terminal T1 and compares the value of the supply voltage Vs with the value of a second reference voltage (second threshold value) Vth2 supplied from the second reference voltage source 82.

The second threshold value Vth2 may be set at, for example, a value equal to the minimum operating voltage of the second load 42. That is to say, if the value of the supply voltage Vs is less than the second threshold value Vth2, then the second load 42 cannot operate properly, and therefore, the main power supply 5 is determined to have caused a failure with respect to the second load 42.

The second detection unit 62 outputs a detection signal D2, which is a voltage signal representing the result of comparison between the value of the supply voltage Vs and the second threshold value Vth2, to the control unit 3. Specifically, if the value of the supply voltage Vs is equal to or greater than the second threshold value Vth2, the second detection unit 62 outputs a detection signal D2 having a voltage value VLo2 to the control unit 3. On the other hand, if the value of the supply voltage Vs is less than the second threshold value Vth2, the second detection unit 62 outputs a detection signal D2, having a voltage value VHi2 higher than the voltage value VLo2, to the control unit 3.

In this case, the first load 41 has a higher minimum operating voltage than the second load 42 as described above. That is to say, the first threshold value Vth1 is set at a higher value than the second threshold value Vth2. Therefore, if the value of the supply voltage Vs is equal to or greater than the first threshold value Vth1, the value of the supply voltage Vs is higher than the second threshold value Vth2. Thus, the control unit 3 receives not only the detection signal D1 having the voltage value VLo1 from the first detection unit 61 but also the detection signal D2 having the voltage value VLo2 from the second detection unit 62. On the other hand, if the value of the supply voltage Vs is lower than the first threshold value Vth1 and equal to or greater than the second threshold value Vth2, the control unit 3 receives not only the detection signal D1 having the voltage value VHi1 from the first detection unit 61 but also the detection signal D2 having the voltage value VLo2 from the second detection unit 62. Furthermore, if the value of the supply voltage Vs is less than the second threshold value Vth2, the control unit 3 receives not only the detection signal D1 having the voltage value VHi1 from the first detection unit 61 but also the detection signal D2 having the voltage value VHi2 from the second detection unit 62.

The control unit 3 is implemented as, for example, a microcomputer including a processor and a memory. That is to say, the control unit 3 is implemented as a computer system including a processor and a memory. The functions of the control unit 3 are performed by making the processor execute an appropriate program. The program may be stored in advance in the memory. Alternatively, the program may also be downloaded via a telecommunications line such as the Internet or distributed after having been stored in a non-transitory storage medium such as a memory card.

The control unit 3 turns the first switch SW1 and the second switch SW2 ON and OFF according to the detection results obtained by the first detection unit 61 and the second detection unit 62. Specifically, the control unit 3 turns the first switch SW1 and the second switch SW2 ON and OFF in accordance with the detection signals provided by the first detection unit 61 and the second detection unit 62.

It will be described in detail later in the “(2.2) Description of operation” section exactly how the control unit 3 performs the switching control on the first switch SW1 and the second switch SW2.

In addition, the control unit 3 controls the operation of the voltage transformer unit 7 in accordance with the detection signals provided by the first detection unit 61 and the second detection unit 62.

The voltage transformer unit 7 may be, for example, a bidirectional DC-DC converter having a plurality of switching elements. The voltage transformer unit 7 is connected between the second switch SW2, the first load 41, and the electrical storage unit 2.

The voltage transformer unit 7 controls a charging voltage to be supplied from the main power supply 5 to the electrical storage unit 2 and a feeding voltage to be supplied from the electrical storage unit 2 to the first load 41 and the second load 42. Specifically, the operation modes of the voltage transformer unit 7 include a charging mode in which the charging voltage to be supplied from the main power supply 5 to the electrical storage unit 2 is controlled and a feeding mode in which the feeding voltage to be supplied from the electrical storage unit 2 to the first load 41 and the second load 42 is controlled. In the charging mode, the control unit 3 turns ON and OFF the plurality of switching elements included in the voltage transformer unit 7, which is implemented as a bidirectional DC-DC converter, to keep the charging voltage to be supplied from the main power supply 5 to the electrical storage unit 2 via the voltage transformer unit 7 constant. On the other hand, in the feeding mode, the control unit 3 turns ON and OFF the plurality of switching elements included in the voltage transformer unit 7 to keep the feeding voltage to be supplied from the electrical storage unit 2 to the first load 41 and the second load 42 via the voltage transformer unit 7 constant.

### (2.2) Description of Operation

Next, it will be described in detail with reference to FIGS. 1-5 exactly how the backup power supply system 1 according to this embodiment operates.

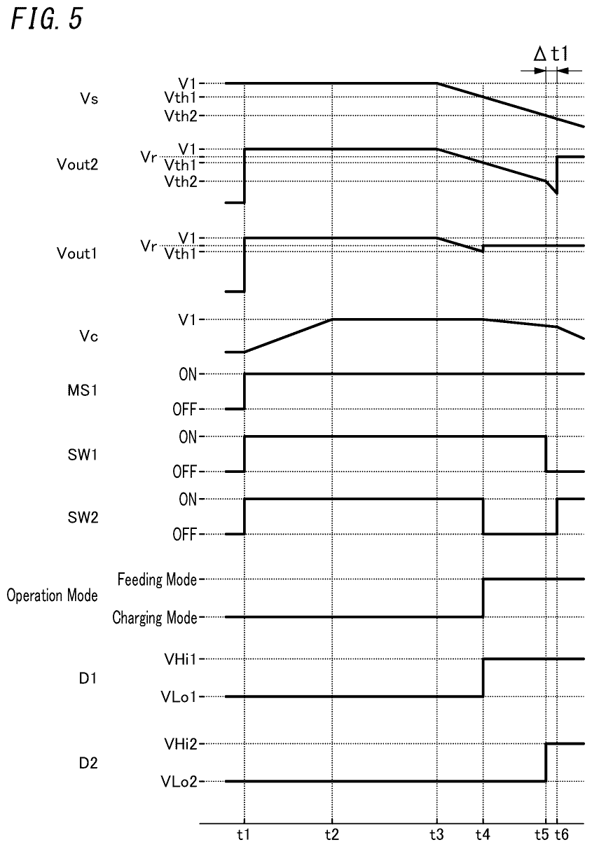

As shown in FIG. 5, when the main switch MS1 turns ON at a time t1, the supply voltage Vs is supplied from the main power supply 5 to the backup power supply system 1 via the first connection terminal T1. At the time t1, the voltage value of the supply voltage Vs is supposed to be a voltage value V1 higher than the first threshold value Vth1. Thus, at the time t1, the first detection unit 61 outputs the detection signal D1 having the voltage value VLo1 to the control unit 3 and the second detection unit 62 outputs the detection signal D2 having the voltage value VLo2 to the control unit 3.

Also, if the voltage value of the supply voltage Vs is equal to or greater than the first threshold value Vth1, then the control unit 3 performs control to have the electrical storage unit 2 charged with electricity by the main power supply 5. That is to say, the voltage value V1 is higher than the first threshold value Vth1 as described above, and therefore, the control unit 3 performs control from the time1 t1 to have the electrical storage unit 2 charged with electricity by the main power supply 5. Specifically, while receiving the detection signal D1 having the voltage value VLo1 and the detection signal D2 having the voltage value VLo2, the control unit 3 controls the first switch SW1 and the second switch SW2 toward ON state and makes the voltage transformer unit 7 operate in the charging mode. Alternatively, while receiving the detection signal D1 having the voltage value VLo1 and the detection signal D2 having the voltage value VLo2, the control unit 3 may control the first switch SW1 toward ON state and control the second switch SW2 toward OFF state. In that case, the supply voltage Vs is applied in the forward direction to the body diode D2 of the second switch SW2.

When the first switch SW1 and the second switch SW2 are controlled toward ON state at the time t1, the electrical storage unit 2 starts to be charged with electricity by the main power supply 5 via the first switch SW1, the second switch SW2, and the voltage transformer unit 7 in the charging mode.

In addition, at this time, the supply voltage Vs having the voltage value V1 is supplied, via the first switch SW1 and the second switch SW2, to the first load 41 connected to the third connection terminal T3 and supplied, via the first switch SW1, to the second load 42 connected to the second connection terminal T2. That is to say, the output voltage Vout1 delivered to the first load 41 and the output voltage Vout2 delivered to the second load 42 have the voltage value V1.

When the charging voltage Vc of the electrical storage unit 2 becomes equal to the voltage value V1 at a time t2, the electrical storage unit 2 finishes being charged. The charging voltage Vc will be maintained at the voltage value V1 after that.

Thereafter, the value of the supply voltage Vs starts to decrease at a time t3 from the voltage value V1 due to failure, deterioration, or disconnection, for example, of the main power supply 5. At the same time, the output voltages Vout1, Vout2 also start to decrease from the voltage value V1.

When the value of the supply voltage Vs decreases to less than the first threshold value Vth1 at a time t4 (i.e., when the main power supply 5 causes a failure with respect to the first load 41), the first detection unit 61 outputs the detection signal D1 having the voltage value VHi1 to the control unit 3 and the second detection unit 62 outputs the detection signal D2 having the voltage value VLo2 to the control unit 3.

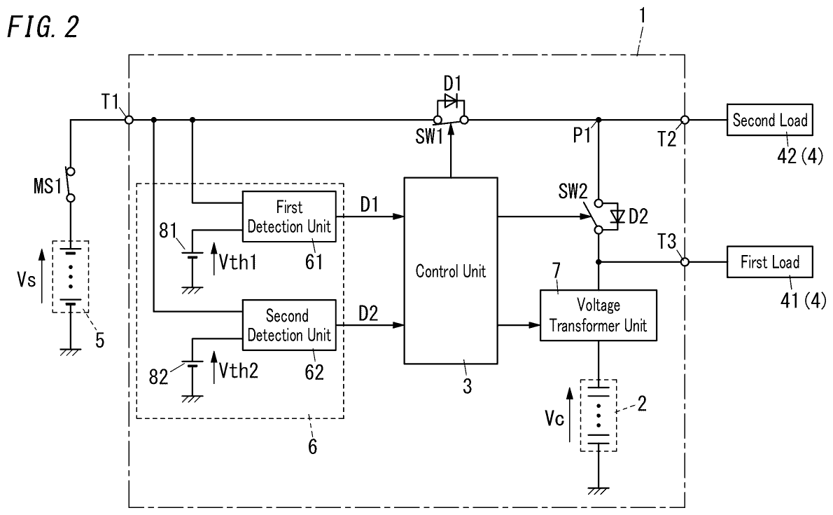

While receiving the detection signal D1 having the voltage value VHi1 and the detection signal D2 having the voltage value VLo2, the control unit 3 controls the second switch SW2 toward OFF state and makes the voltage transformer unit 7 operate in the feeding mode as shown in FIG. 2.

When the second switch SW2 is controlled toward OFF state at the time t4, the output voltage Vout1 having the voltage value Vr is supplied from the electrical storage unit 2 to the first load 41 via the voltage transformer unit 7 operating in the feeding mode. In this case, the voltage value Vr is a value higher than the first threshold value Vth1 and less than the voltage value V1. After that, the output voltage Vout1 will be maintained at the voltage value Vr by the voltage transformer unit 7 operating in the feeding mode. This allows the first load 41 to continue to operate properly even if the main power supply 5 has caused a failure with respect to the first load 41. Meanwhile, the supply voltage Vs less than the first threshold value Vth1 is still supplied continuously to the second load 42 via the first switch SW1. This enables reducing waste of the electrical storage unit 2 compared to a situation where the second load 42 is supplied with electric power from the electrical storage unit 2 even when the supply voltage Vs has a sufficient value for the second load 42 to operate properly.

In this case, the voltage (supply voltage Vs) at the terminal, connected to the connection node P1, of the body diode D2 provided for the second switch SW2 is less than the first threshold value Vth1 and the voltage (output voltage Vout1) at the terminal, connected to the third connection terminal T3 (and connected to the voltage transformer unit 7), of the body diode D2 has the voltage value Vr. Thus, no forward current flows through the body diode D2 provided for the second switch SW2. That is to say, the first load 41 is not supplied with electric power from the main power supply 5.

When electric power starts to be supplied from the electrical storage unit 2 to the first load 41 at the time t4, the charging voltage Vc of the electrical storage unit 2 starts to decrease.

When the value of the supply voltage Vs decreases to less than the second threshold value Vth2 at a time t5 (i.e., when the main power supply 5 causes a failure with respect to the second load 42 as well), the control unit 3 performs control to have the first load 41 and the second load 42 supplied with electric power from the electrical storage unit 2. Specifically, the first detection unit 61 outputs the detection signal D1 having the voltage value VHi1 to the control unit 3 and the second detection unit 62 outputs the detection signal D2 having the voltage value VHi2 to the control unit 3.

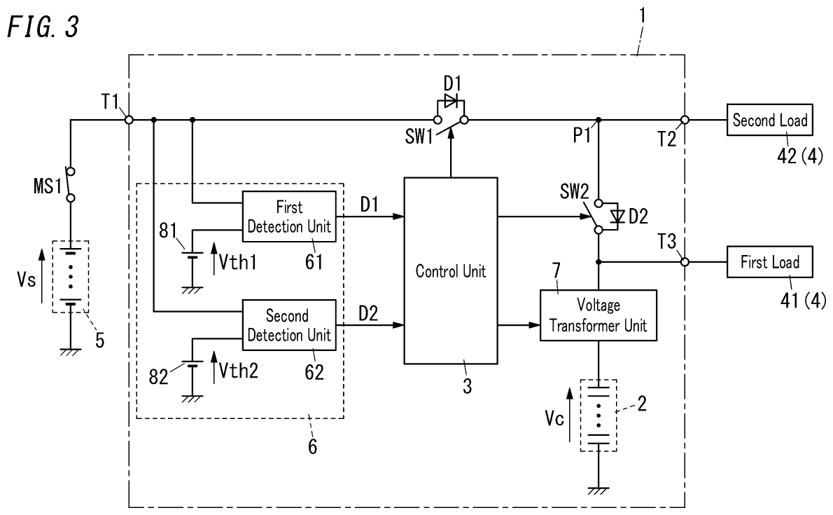

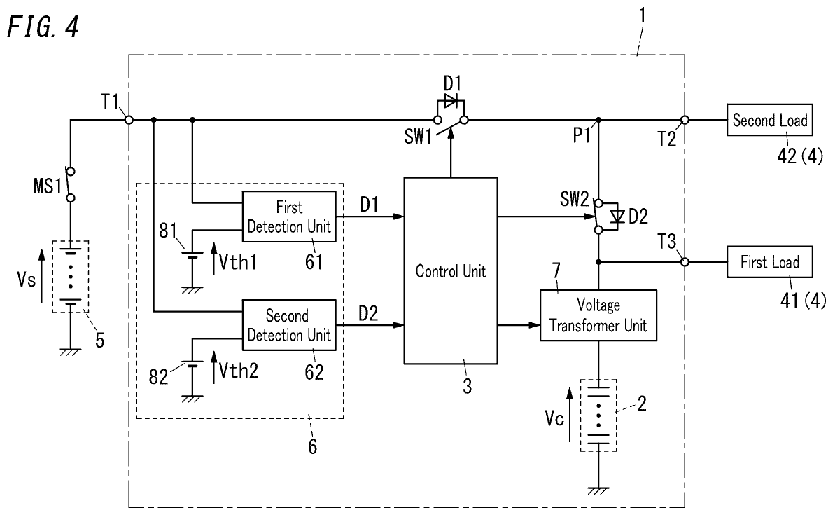

When receiving the detection signal D1 having the voltage value VHi1 and the detection signal D2 having the voltage value VHi2 at the time t5, the control unit 3 controls the first switch SW1 toward OFF state as shown in FIG. 3. Then, at a time t6 when a very short amount of time Δt1 passes, the control unit 3 controls the second switch SW2 toward ON state as shown in FIG. 4. This ensures that the first switch SW1 has been turned OFF when the second switch SW2 is controlled toward the ON state at the time t6, thus preventing a current from flowing from the electrical storage unit 2 into the main power supply 5.

When the second switch SW2 is controlled toward the ON state at the time t6, the output voltages Vout1, Vout2 having the voltage value Vr are supplied from the electrical storage unit 2 to the first load 41 and the second load 42, respectively, via the voltage transformer unit 7 operating in the feeding mode. The voltage value Vr is set at a value higher than the first threshold value Vth1 as described above, and therefore, is higher than the second threshold value Vth2 that is lower than the first threshold value Vth1. This allows the first load 41 and the second load 42 to continue to operate even when the main power supply 5 has caused a failure with respect to both the first load 41 and the second load 42.

### (3) Variations

Variations of the backup power supply system 1 according to the exemplary embodiment will now be described. In the following description, any constituent element of the backup power supply system 1 according to any of the variations, having the same function as a counterpart of the backup power supply system 1 according to the exemplary embodiment described above, will be designated by the same reference numeral as that counterpart's, and description thereof will be omitted as appropriate herein. Optionally, the respective constituent elements of any of the variations to be described below may be adopted in combination with the respective constituent elements described above for the exemplary embodiment.

### (3.1) First Variation

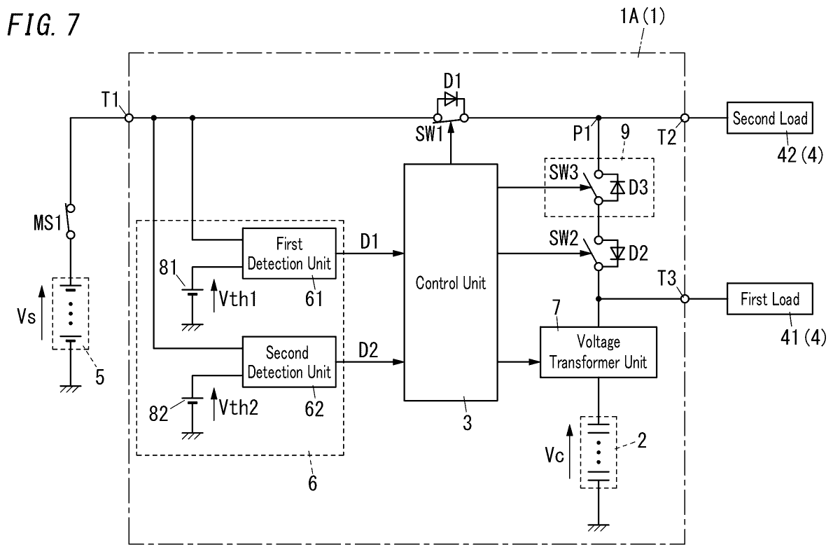

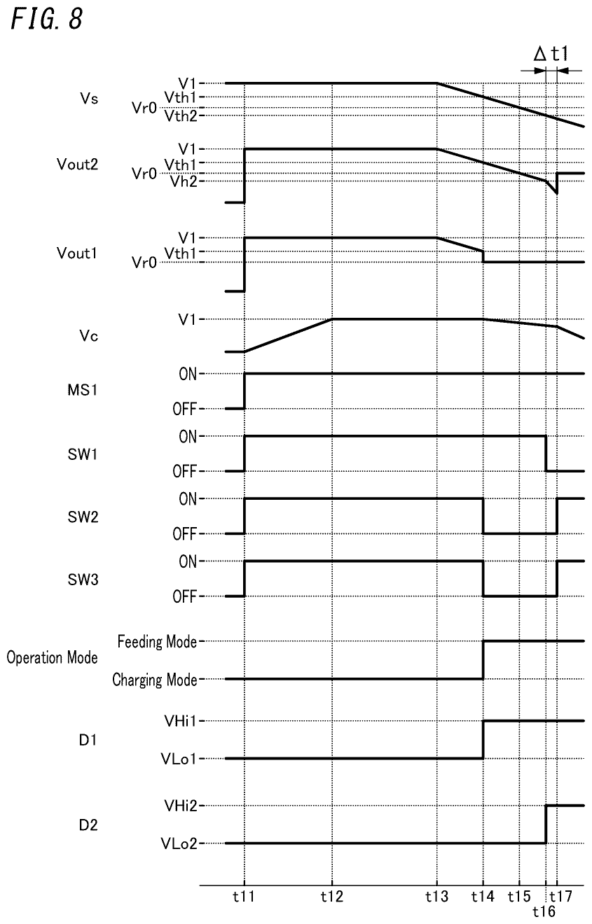

A backup power supply system 1 (1A) according to a first variation of the exemplary embodiment will be described with reference to FIGS. 7 and 8.

In the backup power supply system 1A, a feeding prevention unit 9 is connected between the connection node P1 and the second switch SW2 as shown in FIG. 7, which is a difference from the exemplary embodiment described above.

The feeding prevention unit 9 includes a third switch SW3. The third switch SW3 may be, for example, a p-channel MOSFET. A body diode D3 is provided for the third switch SW3. The body diode D3 has an anode connected to the second switch SW2 and a cathode connected to the connection node P1. That is to say, the body diode D3 of the third switch SW3 is connected in such a direction as to cause a current to flow from the second switch SW2 toward the connection node P1.

The third switch SW3 is turned ON and OFF by the control unit 3.

Next, it will be described in detail with reference to FIG. 8 exactly how the backup power supply system 1A operates.

When the main switch MS1 turns ON at a time t11, a supply voltage Vs having a voltage value V1 is supplied from the main power supply 5 to the backup power supply system 1 via the first connection terminal T1.

At the time t11, the control unit 3 controls the first switch SW1, the second switch SW2, and the third switch SW3 toward ON state to make the voltage transformer unit 7 operate in the charging mode.

When the first switch SW1, the second switch SW2, and the third switch SW3 are controlled toward the ON state at the time t11, the electrical storage unit 2 starts to be charged with electricity by the main power supply 5 via the first switch SW1, the second switch SW2, the third switch SW3, and the voltage transformer unit 7 operating in the charging mode.

In addition, at this time, the supply voltage Vs having the voltage value V1 is supplied, via the first switch SW1, the second switch SW2, and the third switch SW3, to the first load 41 connected to the third connection terminal T3 and supplied, via the first switch SW1, to the second load 42 connected to the second connection terminal T2.

When the charging voltage Vc of the electrical storage unit 2 becomes equal to the voltage value V1 at a time t2, the electrical storage unit 2 finishes being charged. After that, the charging voltage Vc will be maintained at the voltage value V1.

Thereafter, at a time t13, the value of the supply voltage Vs starts to decrease from the voltage value V1 due to failure, deterioration, or disconnection, for example, of the main power supply 5.

When the value of the supply voltage Vs decreases to less than the first threshold value Vth1 at a time t14 (i.e., when the main power supply 5 causes a failure with respect to the first load 41), the control unit 3 controls the second switch SW2 and the third switch SW3 toward OFF state and makes the voltage transformer unit 7 operate in the feeding mode as shown in FIG. 7.

When the second switch SW2 and the third switch SW3 are controlled toward the OFF state at the time t14, an output voltage Vout1 having a voltage value Vr0 is supplied from the electrical storage unit 2 to the first load 41 via the voltage transformer unit 7 operating in the feeding mode. In this case, the voltage value Vr0 is the value of an operating voltage required by the first load 41 and the second load 42 after the main power supply 5 has caused a failure and is a value higher than the second threshold value Vth2 and less than the first threshold value Vth1. After that, the output voltage Vout1 will be maintained at the voltage value Vr0 by the voltage transformer unit 7 operating in the feeding mode. Meanwhile, the supply voltage Vs less than the first threshold value Vth1 is still supplied continuously to the second load 42 via the first switch SW1.

At this time, the voltage (supply voltage Vs) at the terminal, connected to the connection node P1, of the body diode D3 provided for the third switch SW3 is less than the first threshold value Vth1 and the voltage (output voltage Vout1) at the terminal, connected to the third connection terminal T3 (and connected to the voltage transformer unit 7), of the body diode D2 provided for the second switch SW2 has the voltage value Vr0. In this case, in the interval between the time t14 and the time t15, the output voltage Vout1 having the voltage value Vr0 is lower than the supply voltage Vs. In this case, the body diode D3 provided for the third switch SW3 is connected in such a direction as to cause a current to flow from the second switch SW2 toward the connection node P1. Thus, no current flows from the connection node P1 toward the third connection terminal T3. That is to say, the third switch SW3 prevents the first load 41 from being supplied with electric power from the main power supply 5 when the supply voltage Vs is less than the first threshold value Vth1.

When the value of the supply voltage Vs decreases to less than the second threshold value Vth2 at a time t16 (i.e., when the main power supply 5 causes a failure with respect to the second load 42 as well), the control unit 3 controls the first switch SW1 toward OFF state. Then, at a time t17 when a very short amount of time Δt1 passes, the control unit 3 controls the second switch SW2 and the third switch toward ON state. This ensures that the first switch SW1 has been turned OFF when the second switch SW2 and the third switch SW3 are controlled toward the ON state at the time t17, thus preventing a current from flowing from the electrical storage unit 2 into the main power supply 5.

When the second switch SW2 and the third switch SW3 are controlled toward the ON state at the time t17, the output voltages Vout1, Vout2 each having the voltage value Vr0 are supplied from the electrical storage unit 2 to the first load 41 and the second load 42, respectively, via the voltage transformer unit 7 operating in the feeding mode.

As can be seen from the foregoing description, the backup power supply system 1A according to the first variation may prevent, even if the operating voltage (having a voltage value Vr0) required by the first load 41 and the second load 42 is lower than the supply voltage Vs after the main power supply 5 has caused a failure, the first load 41 from being supplied with electric power from the main power supply 5.

### (3.2) Second Variation

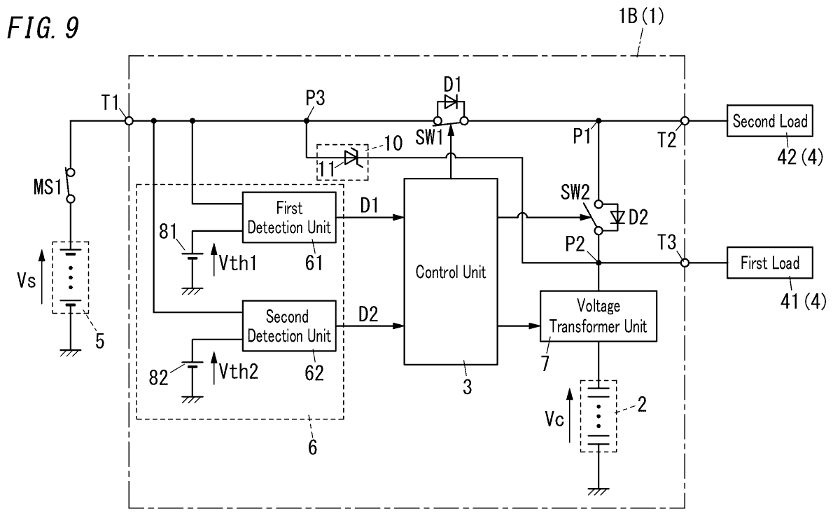

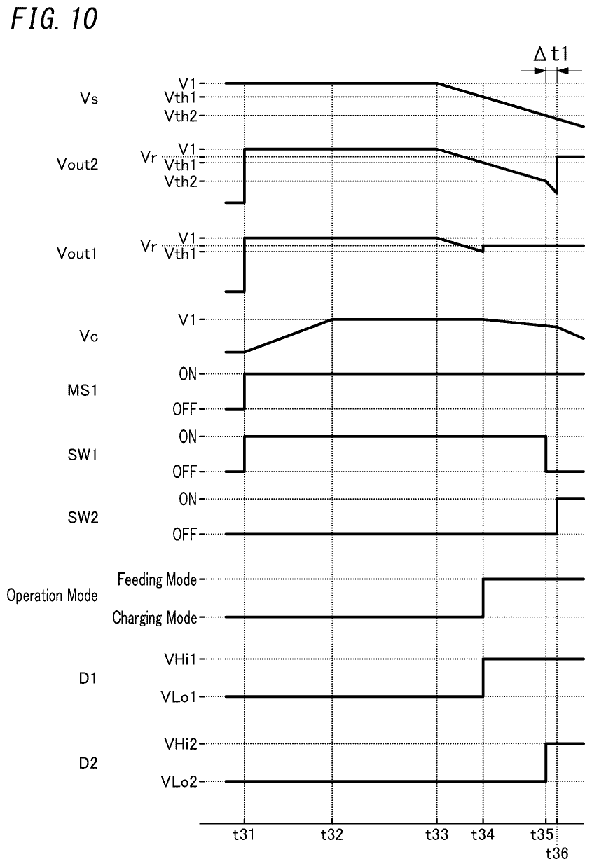

A backup power supply system 1 (1B) according to a second variation of the exemplary embodiment will be described with reference to FIGS. 9 and 10.

The backup power supply system 1B further includes a backflow prevention unit 10 as shown in FIG. 9, which is a difference from the exemplary embodiment described above.

The backflow prevention unit 10 is electrically connected between a connection node P2 where the second switch SW2, the voltage transformer unit 7, and a third connection terminal T3 are connected to each other and the connection node P3 where the first connection terminal T1 and the first switch SW1 are connected to each other. In other words, the backflow prevention unit 10 is connected between the main power supply 5 and the first load 41 and the electrical storage unit 2.

The backflow prevention unit 10 prevents a current from flowing from the electrical storage unit 2 toward the main power supply 5.

The backflow prevention unit 10 may include, for example, a Schottky barrier diode 11. The Schottky barrier diode 11 has an anode connected to the connection node P3 and a cathode connected to the connection node P2. That is to say, the Schottky barrier diode 11 is connected in such a direction as to cause a current to flow from the connection node P3 toward the connection node P2.

In the backup power supply system 1B, if the supply voltage Vs of the main power supply 5 is equal to or greater than the first threshold value Vth1, then the control unit 3 performs control to have the second load 42 supplied with electric power from the main power supply 5 via the first switch SW1 and have the first load 41 supplied with electric power from the main power supply 5 via the backflow prevention unit 10.

Next, it will be described in detail with reference to FIG. 10 exactly how the backup power supply system 1B operates.

When the main switch MS1 turns ON at a time t31, a supply voltage Vs having a voltage value V1 higher than the first threshold value Vth1 is supplied from the main power supply 5 to the backup power supply system 1 via the first connection terminal T1 as shown in FIG. 10.

At the time t31, the voltage value V1 of the supply voltage Vs is equal to or greater than the first threshold value Vth1, and therefore, the control unit 3 controls the first switch SW1 toward ON state and controls the second switch SW2 toward OFF state to make the voltage transformer unit 7 operate in the charging mode.

When the first switch SW1 is controlled toward the ON state and the second switch SW2 is controlled toward the OFF state at the time t31, the electrical storage unit 2 starts to be charged with electricity by the main power supply 5 via the (Schottky barrier diode 11 of the) backflow prevention unit 10 and the voltage transformer unit 7 operating in the charging mode. Meanwhile, the first load 41 is supplied with the supply voltage Vs having the voltage value V1 via the Schottky barrier diode 11. In this case, the Schottky barrier diode 11 has a lower forward voltage than any of the body diodes D1, D2, and therefore, the current flows from the main power supply 5 toward the electrical storage unit 2 and the first load 41 via the Schottky barrier diode 11.

The second load 42 is supplied with the supply voltage Vs having the voltage value V1 via the first switch SW1.

When the charging voltage Vc of the electrical storage unit 2 becomes equal to the voltage value V1 at a time t32, the electrical storage unit 2 finishes being charged. After that, the charging voltage Vc will be maintained at the voltage value V1.

At a time t33, the value of the supply voltage Vs starts to decrease from the voltage value V1 due to failure, deterioration, or disconnection, for example, of the main power supply 5. At the same time, the output voltages Vout1, Vout2 also start to decrease from the voltage value V1.

When the value of the supply voltage Vs decreases to less than the first threshold value Vth1 at a time t34 (i.e., when the main power supply 5 causes a failure with respect to the first load 41), the first detection unit 61 outputs the detection signal D1 having the voltage value VHi1 to the control unit 3 and the second detection unit 62 outputs the detection signal D2 having the voltage value VLo2 to the control unit 3.

While receiving the detection signal D1 having the voltage value VHi1 and the detection signal D2 having the voltage value VLo2, the control unit 3 makes the voltage transformer unit 7 operate in the feeding mode.

After that, the backup power supply system 1B will operate as already described for the exemplary embodiment. Thus, description thereof will be omitted herein.

As can be seen from the foregoing description, the backup power supply system 1B according to the second variation may supply electric power from the main power supply 5 to the second load 42 via the first switch SW1 and may supply electric power from the main power supply 5 to the first load 41 and the electrical storage unit 2 via the backflow prevention unit 10. This enables reducing the deterioration of the first switch SW1 compared to a situation where electric power is supplied from the main power supply 5 to the first load 41, the second load 42, and the electrical storage unit 2 via the first switch SW1 as in the exemplary embodiment described above.

Optionally, in the first variation described above, the backflow prevention unit 10 may also be electrically connected as in this second variation between a connection node (corresponding to the connection node P2 according to the second variation) where the second switch SW2, the voltage transformer unit 7, and the third connection terminal T3 are connected to each other and a connection node (corresponding to the connection node P3 according to the second variation) where the first connection terminal T1 and the first switch SW1 are connected to each other. Then, the advantages of the second variation may also be achieved by the first variation.

### (3.3) Third Variation

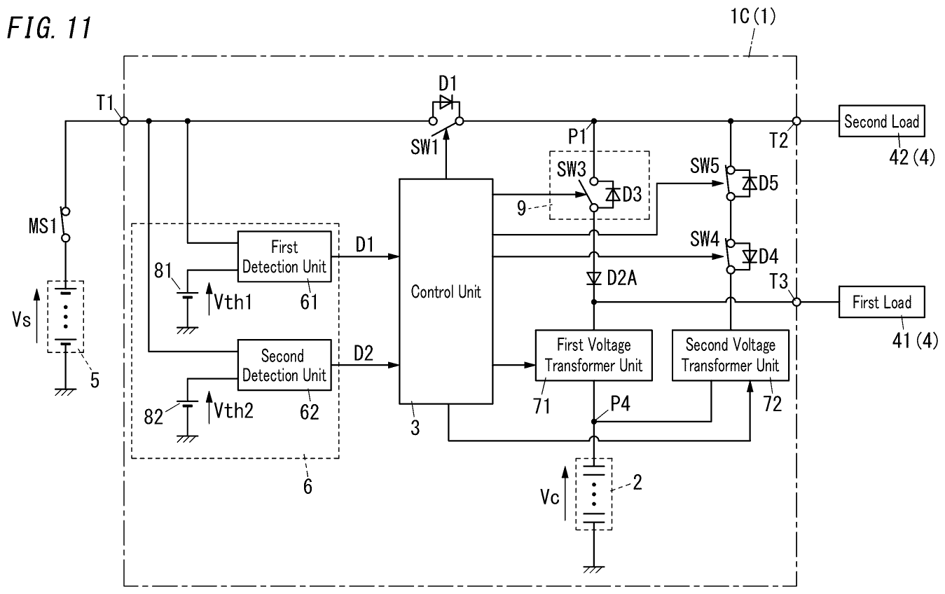

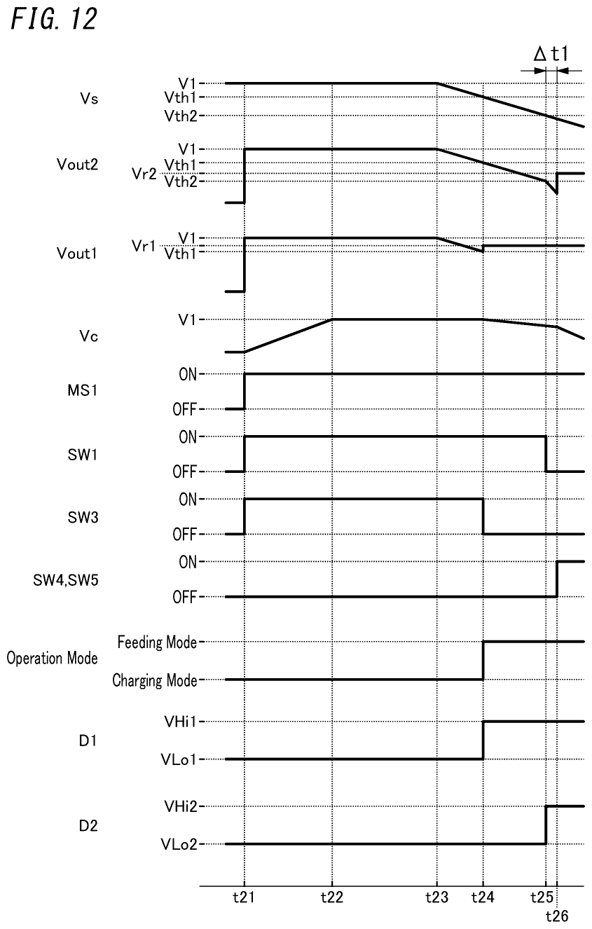

A backup power supply system 1 (1C) according to a third variation of the exemplary embodiment will be described with reference to FIGS. 11 and 12.

The backup power supply system 1C further includes a diode D2A, the third switch SW3, a fourth switch SW4, a fifth switch SW5, a first voltage transformer unit 71, and a second voltage transformer unit 72 as shown in FIG. 11, which is a difference from the exemplary embodiment, the first variation, and the second variation described above.

The diode D2A is connected, in place of the second switch SW2 according to the exemplary embodiment, between the connection node P1 and the third connection terminal T3. The diode D2A is connected in such a direction as to cause a current to flow from the connection node Pl toward the third connection terminal T3. Alternatively, the functions of the diode D2A may also be performed by, for example, a p-channel MOSFET. In that case, a body diode provided for the p-channel MOSFET is connected in such a direction as to cause a current to flow from the connection node P1 toward the third connection terminal T3. In this case, making the control unit 3 always control the p-channel MOSFET toward OFF state allows the p-channel MOSFET to achieve the same advantages as the diode D2A.

The third switch SW3 is connected between the connection node P1 and the diode D2A. The third switch SW3 has the same features as the third switch SW3 according to the first variation other than its connection location, and therefore, description thereof will be omitted herein.

The first voltage transformer unit 71 is connected, in place of the voltage transformer unit 7 according to the exemplary embodiment, between the diode D2A and the first load 41 and the electrical storage unit 2.

The first voltage transformer unit 71 controls a charging voltage to be supplied from the main power supply 5 to the electrical storage unit 2. In addition, the first voltage transformer unit 71 also controls a feeding voltage to be supplied from the electrical storage unit 2 to the first load 41 at a first voltage value Vr1. Specifically, the operation modes of the first voltage transformer unit 71 include a charging mode in which the charging voltage to be supplied from the main power supply 5 to the electrical storage unit 2 is controlled and a feeding mode in which the feeding voltage to be supplied from the electrical storage unit 2 to the first load 41 is controlled. In the charging mode, the control unit 3 turns ON and OFF the plurality of switching elements included in the first voltage transformer unit 71 to keep the charging voltage to be supplied from the main power supply 5 to the electrical storage unit 2 via the first voltage transformer unit 71 constant. On the other hand, in the feeding mode, the control unit 3 turns ON and OFF the plurality of switching elements included in the first voltage transformer unit 71 to maintain the feeding voltage to be supplied from the electrical storage unit 2 to the first load 41 via the first voltage transformer unit 71 at the first voltage value Vr1.

The second voltage transformer unit 72 may be, for example, a DC-DC converter including a plurality of switching elements.

The second voltage transformer unit 72 is connected between a connection node P4 where the electrical storage unit 2 and the first voltage transformer unit 71 are connected to each other and the second load 42 as shown in FIG. 11.

The second voltage transformer unit 72 controls the feeding voltage to be supplied from the electrical storage unit 2 to the second load 42 at a second voltage value Vr2 different from the first voltage value Vr1. Specifically, the control unit 3 turns ON and OFF the plurality of switching elements included in the second voltage transformer unit 72 to maintain the feeding voltage to be supplied from the electrical storage unit 2 to the second load 42 via the second voltage transformer unit 72 at a second voltage value Vr2 different from the first voltage value Vr1.

The fourth switch SW4 may be, for example, a p-channel MOSFET. The fourth switch SW4 is connected between the second voltage transformer unit 72 and the second connection terminal T2 (i.e., between the second voltage transformer unit 72 and the second load 42). A body diode D4 is provided for the fourth switch SW4. The body diode D4 of the fourth switch SW4 is connected in such a direction as to cause a current to flow from the second connection terminal T2 toward the second voltage transformer unit 72.

The fourth switch SW4 is turned ON and OFF by the control unit 3.

The fifth switch SW5 may be, for example, a p-channel MOSFET. The fifth switch SW5 is connected between the fourth switch SW4 and the second connection terminal T2 (i.e., between the fourth switch SW4 and the second load 42). A body diode D5 is provided for the fifth switch SW5. The body diode D5 of the fifth switch SW5 is connected in such a direction as to cause a current to flow from the fourth switch SW4 toward the second connection terminal T2.

The fifth switch SW5 is turned ON and OFF by the control unit 3.

Next, it will be described in detail with reference to FIG. 12 exactly how the backup power supply system 1C operates.

When the main switch MS1 turns ON at a time t21, a supply voltage Vs having the voltage value V1 is supplied from the main power supply 5 to the backup power supply system 1C via the first connection terminal T1 as shown in FIG. 12.

At the time t21, the control unit 3 controls the first switch SW1 and the third switch SW3 toward ON state and controls the fourth switch SW4 and the fifth switch SW5 toward OFF state to make the first voltage transformer unit 71 operate in the charging mode.

When the first switch SW1 and the third switch SW3 are controlled toward the ON state at the time t21, the electrical storage unit 2 starts to be charged with electricity by the main power supply 5 via the first switch SW1, the third switch SW3, the diode D2A, and the first voltage transformer unit 71 operating in the charging mode.

Meanwhile, the first load 41 is supplied with the supply voltage Vs having the voltage value V1 via the first switch SW1, the third switch SW3, and the diode D2A. The second load 42 is supplied with the supply voltage Vs having the voltage value V1 via the first switch SW1.

When the charging voltage Vc of the electrical storage unit 2 becomes equal to the voltage value V1 at a time t22, the electrical storage unit 2 finishes being charged. After that, the charging voltage Vc will be maintained at the voltage value V1.

Thereafter, at a time t23, the value of the supply voltage Vs starts to decrease from the voltage value V1 due to failure, deterioration, or disconnection, for example, of the main power supply 5.

When the value of the supply voltage Vs decreases to less than the first threshold value Vth1 at a time t24 (i.e., when the main power supply 5 causes a failure with respect to the first load 41), the control unit 3 controls the third switch SW3 toward OFF state and makes the first voltage transformer unit 71 operate in the feeding mode.

When the third switch SW3 is controlled toward OFF state at the time t24, the output voltage Vout1 having the first voltage value Vr1 is supplied from the electrical storage unit 2 to the first load 41 via the first voltage transformer unit 71 operating in the feeding mode. In this case, the first voltage value Vr1 is a value required by the first load 41 after the main power supply 5 has caused a failure with respect to the first load 41 and is higher than the first threshold value Vth1 and less than the voltage value V1. Thereafter, the output voltage Vout1 will be maintained at the first voltage value Vr1 by the first voltage transformer unit 71 operating in the feeding mode. Meanwhile, the supply voltage Vs less than the first threshold value Vth1 is still supplied continuously to the second load 42 via the first switch SW1.

When the value of the supply voltage Vs decreases to less than the second threshold value Vth2 at a time t25 (i.e., when the main power supply 5 causes a failure with respect to the second load 42 as well), the control unit 3 controls the first switch SW1 toward OFF state. Then, at a time t26 when a very short amount of time Δt1 passes, the control unit 3 controls the fourth switch SW4 and the fifth switch SW5 toward ON state (refer to FIG. 11). This ensures that the first switch SW1 has been turned OFF when the fourth switch SW4 and the fifth switch SW5 are controlled toward the ON state at the time t26, thus preventing a current from flowing from the electrical storage unit 2 into the main power supply 5.

When the fourth switch SW4 and the fifth switch SW5 are controlled toward the ON state at the time t26, the output voltage Vout2 having a second voltage value Vr2 different from the first voltage value Vr1 is supplied from the electrical storage unit 2 to the second load 42, via the second voltage transformer unit 72. In this case, the second voltage value Vr2 is a value of operating voltage required by the second load 42 after the main power supply 5 has caused a failure with respect to the second load 42 and is higher than the second threshold value Vth2 and less than the first threshold value Vth1. Thereafter, the output voltage Vout2 will be maintained at the second voltage value Vr2 by the second voltage transformer unit 72.

As can be seen from the foregoing description, even if the operating voltage (having the first voltage value Vr1) required by the first load 41 after the main power supply 5 has caused a failure with respect to the first load 41 and the operating voltage (having the second voltage value Vr2) required by the second load 42 after the main power supply 5 has caused a failure with respect to the second load 42 are different from each other, the backup power supply system 1C according to this third variation may still supply the output voltage Vout1 having the first voltage value Vr1 and the output voltage Vout2 having the second voltage value Vr2 to the first load 41 and the second load 42, respectively.

### (3.4) Other Variations

Next, other variations of the exemplary embodiment will be enumerated one after another. Note that the variations to be described below may be adopted in combination as appropriate.

The backup power supply system 1 according to the present disclosure includes a computer system. The computer system includes a processor and a memory as principal hardware components thereof. The computer system performs the functions of the backup power supply system 1 according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment described above, the plurality of functions of the backup power supply system 1 are aggregated together in a single housing. However, this is not an essential configuration for the backup power supply system 1. Alternatively, those constituent elements of the backup power supply system 1 may be distributed in multiple different housings.

Furthermore, in the foregoing description of embodiments, if one of two values being compared with each other (such as the electrical characteristic of the main power supply 5 as detected by the first detection unit 61 and the first threshold value Vth1 and the electrical characteristic of the main power supply 5 as detected by the second detection unit 62 and the second threshold value Vth2) is “less than” the other, the phrase “less than” may also be a synonym of the phrase “equal to or less than.” That is to say, it is arbitrarily changeable, depending on selection of a reference value or any preset value, whether or not the phrase “less than” covers the situation where the two values are equal to each other. Therefore, from a technical point of view, there is no difference between the phrase “less than” and the phrase “equal to or less than.” Similarly, the phrase “equal to or greater than” may be a synonym of the phrase “greater than” as well in the embodiment described above.

The load 4 as the target of control for the control unit 3 is not limited to the two loads (namely, the first load 41 and the second load 42) but may include n loads where n is a natural number equal to or greater than three. Those n loads are connected together via (n−1) switches (corresponding to the second switch SW2 in the exemplary embodiment described above), of which the ON/OFF states are controlled by the control unit 3. In that case, the backup power supply system 1 may be configured such that the control unit 3 controls two loads electrically connected to each other via a switch which belong to the n loads in the same way as the first load 41 and the second load 42 according to the exemplary embodiment described above.

### (4) Recapitulation

As can be seen from the foregoing description, a backup power supply system (1; 1A; 1B; 1C) according to a first aspect includes an electrical storage unit (2) and a control unit (3). The electrical storage unit (2) supplies electric power to a load (4) according to an electrical characteristic of a main power supply (5). The main power supply (5) supplies electric power to the load (4). The control unit (3) controls the supply of the electric power from the main power supply (5) and the electrical storage unit (2) to the load (4). The load (4) includes a first load (41) and a second load (42). When the electrical characteristic of the main power supply (5) is equal to or greater than a first threshold value (Vth1), the control unit (3) performs control to have both the first load (41) and the second load (42) supplied with the electric power from the main power supply (5). On the other hand, when the electrical characteristic of the main power supply (5) is less than the first threshold value (Vth1), the control unit (3) performs control to have the second load (42) supplied with the electric power from the main power supply (5) and have the first load (41) supplied with the electric power from the electrical storage unit (2).

This aspect allows, in a situation where the main power supply (5) has caused a failure with respect to the first load (41) but the electrical characteristic of the main power supply (5) has a sufficient value for the second load (42) to operate properly, the second load (42) to be supplied with electric power from the main power supply (5). This enables reducing waste of the electrical storage unit (2) compared to a situation where the second load (42) is supplied with electric power from the electrical storage unit (2) even when the electrical characteristic of the main power supply (5) has a sufficient value for the second load (42) to operate properly.

In a backup power supply system (1; 1A; 1B; 1C) according to a second aspect, which may be implemented in conjunction with the first aspect, the first load (41) has a higher minimum operating voltage than the second load (42).

This aspect allows the electrical storage unit (2) to supply electric power preferentially to the first load (41) which requires a higher voltage for operation.

In a backup power supply system (1; 1A; 1B; 1C) according to a third aspect, which may be implemented in conjunction with the first or second aspect, when the electrical characteristic of the main power supply (5) is less than a second threshold value (Vth2) that is lower than the first threshold value (Vth1), the control unit (3) performs control to have both the first load (41) and the second load (42) supplied with the electric power from the electrical storage unit (2).

This aspect allows, even if the main power supply (5) has caused a failure with respect to the first load (41) and the second load (42), the first load (41) and the second load (42) to still operate properly.

A backup power supply system (1; 1A; 1B; 1C) according to a fourth aspect, which may be implemented in conjunction with any one of the first to third aspects, further includes a feeding prevention unit (9) configured to, when the electrical characteristic of the main power supply (5) is less than the first threshold value (Vth1), prevent the first load (41) from being supplied with the electric power from the main power supply (5).

This aspect may prevent the first load (41) from being supplied with electric power from the main power supply (5) even when the operating voltages required by the first load (41) and the second load (42) are lower than a supply voltage (Vs) after the main power supply (5) has caused a failure. That is to say, this aspect may reduce the chances of the second load (42) being supplied with insufficient electric power from the main power supply (5).

A backup power supply system (1; 1A; 1B; 1C) according to a fifth aspect, which may be implemented in conjunction with any one of the first to fourth aspects, further includes: a switch (SW1) connected between the main power supply (5) and the second load (42); and a backflow prevention unit (10) connected between the main power supply (5) and the first load (41) and the electrical storage unit (2). When the electrical characteristic of the main power supply (5) is equal to or greater than the first threshold value (Vth1), the control unit (3) performs control to have the second load (42) supplied with the electric power from the main power supply (5) via the switch (SW1) and to have the first load (41) supplied with the electric power from the main power supply (5) via the backflow prevention unit (10).

This aspect allows the second load (42) to be supplied with electric power from the main power supply (5) via the first switch (SW1) and also allows the first load (41) and the electrical storage unit (2) to be supplied with electric power from the main power supply (5) via the backflow prevention unit (10). This enables reducing the deterioration of the first switch (SW1) compared to a situation where the first load (41), the second load (42), and the electrical storage unit (2) are supplied with electric power from the main power supply (5) via the first switch (SW1).

In a backup power supply system (1; 1A; 1B; 1C) according to a sixth aspect, which may be implemented in conjunction with the fifth aspect, the backflow prevention unit (10) includes a Schottky barrier diode (11).

This aspect allows the second load (42) to be supplied with electric power from the main power supply (5) via the first switch (SW1) and also allows the first load (41) and the electrical storage unit (2) to be supplied with electric power from the main power supply (5) via the Schottky barrier diode (11). This enables reducing the deterioration of the first switch (SW1) compared to a situation where the first load (41), the second load (42), and the electrical storage unit (2) are supplied with electric power from the main power supply (5) via the first switch (SW1).

In a backup power supply system (1; 1A; 1B; 1C) according to a seventh aspect, which may be implemented in conjunction with any one of the first to sixth aspects, the control unit (3) is configured to, when the electrical characteristic of the main power supply (5) is equal to or greater than the first threshold value (Vth1), perform control to have the electrical storage unit (2) charged with electricity by the main power supply (5).

This aspect allows, in a situation where the main power supply (5) has caused no failure with respect to the first load (41), the first load (41) to be supplied with electric power, and the electrical storage unit (2) to be charged with electricity, by the main power supply (5).

A backup power supply system (1; 1A; 1B; 1C) according to an eighth aspect, which may be implemented in conjunction with the seventh aspect, further includes a voltage transformer unit (7) that controls a charging voltage to be supplied from the main power supply (5) to the electrical storage unit (2) and a feeding voltage to be supplied from the electrical storage unit (2) to the load (4).

This aspect allows the charging voltage to be supplied with good stability from the main power supply (5) to the electrical storage unit (2) and also allows the feeding voltage to be supplied with good stability from the electrical storage unit (2) to the load (4).

A backup power supply system (1; 1A; 1B; 1C) according to a ninth aspect, which may be implemented in conjunction with the seventh aspect, further includes a first voltage transformer unit (71) and a second voltage transformer unit (72). The first voltage transformer unit (71) controls a charging voltage to be supplied from the main power supply (5) to the electrical storage unit (2) and controls a feeding voltage to be supplied from the electrical storage unit (2) to the first load (41) at a first voltage value (Vr1). The second voltage transformer unit (72) controls a feeding voltage to be supplied from the electrical storage unit (2) to the second load (42) at a second voltage value (Vr2) different from the first voltage value (Vr1).

This aspect allows, even if the first voltage value (Vr1) required by the first load (41) after the main power supply (5) has caused a failure with respect to the first load (41) and the second voltage value (Vr2) required by the second load (42) after the main power supply (5) has caused a failure with respect to the second load (42) are different from each other, an output voltage (Vout1) having the first voltage value (Vr1) and an output voltage (Vout2) having the second voltage value (Vr2) to be supplied to the first load (41) and the second load (42), respectively.

A backup power supply system (1; 1A; 1B; 1C) according to a tenth aspect, which may be implemented in conjunction with any one of the first to ninth aspects, further includes: a first switch (SW1) connected between the main power supply (5) and the second load (42); a second switch (SW2) connected between the first switch (SW1) and the first load (41); and a detection unit (6) that detects the electrical characteristic of the main power supply (5). The control unit (3) turns the first switch (SW1) and the second switch (SW2) ON and OFF according to detection results obtained by the detection unit (6).

This aspect allows, in a situation where the main power supply (5) has caused a failure with respect to the first load (41) but the electrical characteristic of the main power supply (5) has a sufficient value for the second load (42) to operate properly, the second load (42) to be supplied with electric power from the main power supply (5). This enables reducing waste of the electrical storage unit (2) compared to a situation where the second load (42) is supplied with electric power from the electrical storage unit (2) even when the electrical characteristic of the main power supply (5) has a sufficient value for the second load (42) to operate properly.

A moving vehicle (100) according to an eleventh aspect includes the backup power supply system (1; 1A; 1B; 1C) according to any one of the first to tenth aspects and a moving vehicle body (101) to be equipped with the backup power supply system (1; 1A; 1B; 1C), the main power supply (5), and the load (4).

Note that the constituent elements according to the second to tenth aspects are not essential constituent elements for the backup power supply system (1; 1A; 1B; 1C) but may be omitted as appropriate.

### REFERENCE SIGNS LIST

1, 1A, 1B, 1C Backup Power Supply System
2 Electrical Storage Unit
3 Control Unit
4 Load
5 Main Power Supply
6 Detection Unit
7 Voltage Transformer Unit
9 Feeding Prevention Unit
10 Backflow Prevention Unit
41 First Load
42 Second Load
71 First Voltage Transformer Unit
72 Second Voltage Transformer Unit
100 Moving Vehicle
SW1 First Switch
SW1 First Switch
SW2 Second Switch
Vout1 Output Voltage
Vout2 Output Voltage
Vr1 First Voltage Value
Vr2 Second Voltage Value
Vs Supply Voltage
Vth1 First Threshold Value
Vth2 Second Threshold Value

1. A backup power supply system comprising:
an electrical storage unit configured to supply electric power to a load according to an electrical characteristic of a main power supply, the main power supply being configured to supply electric power to the load; and
a control unit configured to control supply of the electric power from the main power supply and the electrical storage unit to the load,
the load including a first load and a second load,
the control unit being configured to:
when the electrical characteristic of the main power supply is equal to or greater than a first threshold value, perform control to have both the first load and the second load supplied with the electric power from the main power supply, and
when the electrical characteristic of the main power supply is less than the first threshold value, perform control to have the second load supplied with the electric power from the main power supply and have the first load supplied with the electric power from the electrical storage unit.

2. The backup power supply system of claim 1, wherein
the first load has a higher minimum operating voltage than the second load.

3. The backup power supply system of claim 1, wherein
the control unit is configured to, when the electrical characteristic of the main power supply is less than a second threshold value that is lower than the first threshold value, perform control to have both the first load and the second load supplied with the electric power from the electrical storage unit.

4. The backup power supply system of claim 1, further comprising a feeding prevention unit configured to, when the electrical characteristic of the main power supply is less than the first threshold value, prevent the first load from being supplied with the electric power from the main power supply.

5. The backup power supply system of claim 1, further comprising:
a switch connected between the main power supply and the second load; and
a backflow prevention unit connected between the main power supply and the first load and the electrical storage unit, wherein
the control unit is configured to:
when the electrical characteristic of the main power supply is equal to or greater than the first threshold value, perform control to have the second load supplied with the electric power from the main power supply via the switch and to have the first load supplied with the electric power from the main power supply via the backflow prevention unit.

6. The backup power supply system of claim 5, wherein
the backflow prevention unit includes a Schottky barrier diode.

7. The backup power supply system of claim 1, wherein
the control unit is configured to, when the electrical characteristic of the main power supply is equal to or greater than the first threshold value, perform control to have the electrical storage unit charged with electricity by the main power supply.

8. The backup power supply system of claim 7, further comprising a voltage transformer unit configured to control a charging voltage to be supplied from the main power supply to the electrical storage unit and a feeding voltage to be supplied from the electrical storage unit to the load.

9. The backup power supply system of claim 7, further comprising:
a first voltage transformer unit configured to control a charging voltage to be supplied from the main power supply to the electrical storage unit and control a feeding voltage to be supplied from the electrical storage unit to the first load at a first voltage value; and
a second voltage transformer unit configured to control a feeding voltage to be supplied from the electrical storage unit to the second load at a second voltage value different from the first voltage value.

10. The backup power supply system of claim 1, further comprising:
a first switch connected between the main power supply and the second load;
a second switch connected between the first switch and the first load; and
a detection unit configured to detect the electrical characteristic of the main power supply, wherein
the control unit is configured to turn the first switch and the second switch ON and OFF according to detection results obtained by the detection unit.

11. A moving vehicle comprising:
the backup power supply system of claim 1; and
a moving vehicle body to be equipped with the backup power supply system, the main power supply, and the load.
